(19) United States
(12) Patent Application Publication
(10) Pub. No.: US 2012/0262431 A1
(43) Pub. Date: Oct. 18, 2012

(54) HALF SOURCE DRIVING DISPLAY PANEL

(75) Inventors: Hsiao-Chung Cheng, Hsin-Chu (TW); Chao-Ching Hsu, Hsin-Chu (TW)

(73) Assignee: AU OPTRONICS CORP., HSINCHU (TW)

(21) Appl. No.: 13/352,811

(22) Filed: Jan. 18, 2012

(30) Foreign Application Priority Data
Apr. 12, 2011 (TW) 100112705

(51) Int. Cl. G06F 3/038

(52) U.S. Cl. 345/204

(57) ABSTRACT

A half source driving display panel includes a first to a fourth data line, a plurality of pixels, and a plurality of gate lines including a first and a second gate line. The two pixels disposed between the first and the second gate line and between the first and the second data line are driven by one of the first and the second gate line, and so do the two pixels disposed between the first and the second gate line and between the third and the fourth data line. Two pixels disposed between the first and the second gate line and between the second and the third data line are driven by the other one of the first and the second gate line.

### TECHNICAL FIELD

The present invention relates to display panels, and more particularly to a half source driving display panel.

### BACKGROUND

Along with development of display panels, various display panels are used by users. Manufacturing cost and image quality both are important factors impacting competitiveness of display panel products, and display panel driving technology is one of the factors affecting the image quality of the display panel. A half source driving display panel has a reduced manufacturing cost, since a number of data lines thereof are reduced to a half.

FIG. 1 schematically illustrates a pixel array diagram of a conventional half source driving display panel 100. The half source driving display panel 100 includes a plurality of gate lines G₁˜G₄, a plurality of data lines D₁˜D₄, and a plurality of pixels P₁₁˜P₂₈. In order to conveniently describe the structure of the display panel 100, a pixel P_{xy} is defined as a pixel positioned on row x, column y, wherein 1≦x≦4, 1≦y≦4. For example, the pixel P₁₂ represents a pixel positioned on the first row, the second column, and so on.

In order to clearly describe the conventional display panel 100, two pixels electrically connected to the same data line and disposed between same adjacent gate lines are defined as a pixel unit (e.g., pixel unit 110), wherein one of the pixels is electrically connected to one of the adjacent gate lines, and the other one of the pixels is electrically connected to the other one of the adjacent gate lines. The half source display panel 100 includes a plurality of pixel units similar to the pixel unit 110, wherein the two pixels of each pixel unit are disposed at opposite sides of the corresponding data line connecting thereto and are positioned at the same row. For example, one of the pixel units includes two pixels P₁₅ and P₁₆ electrically connected to the data line D₃. The pixel P₁₅ and the pixel P₁₆ are positioned at opposite sides of the data line D₃, and between the gate line G₁ and the gate line G₂, and so the other pixels.

In detail, the polarity of the display data provided by the data line makes the two pixels of one pixel unit have same polarity during a period for displaying a frame of image, and each pixel of one pixel unit has opposite polarity to the adjacent pixels of the adjacent pixel units. However, when the gray level of an display image changes from black to white (as shown in FIG. 2), a response time of the polarity of the liquid crystal changing from positive to negative is different to a response time of the polarity of the liquid crystal changing from negative to positive, which affects the uniformity of the brightness of the display image. In addition, the human eyes are sensitive to the differences of lateral vision, so the driving method of the aforesaid half source driving display panel 100 obviously affects the uniformity of the brightness of the display image.

### SUMMARY

According to one embodiment of the disclosure, a first exemplary half source driving display panel is provided. The display panel includes a first data line, a second data line, a plurality of pixels and a plurality of gate lines. The first and the second data lines are configured for providing display data, and are disposed adjacent to each other. Each of the pixels receives display data provided by one of the first data line and the second data line. The gate lines include a first to a fourth gate line disposed in order. Two pixels electrically connected to the first and the second data lines respectively, and disposed between the first and the second data lines and between the first and the second gate lines are driven by the second gate line. Two pixels electrically connected to the first and the second data lines respectively, and disposed outside the first and the second data lines and between the first and second gate lines are driven by the first gate line. Two pixels electrically connected to the first and the second data lines respectively, and disposed between the first and second data lines and between the third and the fourth gate lines are driven by the third gate line. Two pixels electrically connected to the first and second data lines respectively, and disposed outside the first and the second data lines and between the third and the fourth gate lines are driven by the fourth gate line.

In the first exemplary embodiment, the gate lines further include a fifth to an eighth gate line disposed following the fourth gate line in order. Two pixels electrically connected to the first and the second data lines respectively, and disposed between the first and the second data lines and between the fifth and the sixth gate lines are driven by the fifth gate line. Two pixels electrically connected to the first and the second data lines respectively, and disposed outside the first and the second data lines and between the fifth and the sixth gate lines are driven by the sixth gate line. Two pixels electrically connected to the first and the second data lines respectively, and disposed between the first and the second data lines and between the seventh and the eighth gate lines are driven by the eighth gate line. Two pixels electrically connected to the first and the second data lines respectively, and disposed outside the first and the second data lines and between the seventh and the eighth gate lines are driven by the seventh gate line.

According to one embodiment of the disclosure, a second exemplary half source driving display panel is provided. The display panel includes a first data line, a second data line, a plurality of pixels and a plurality of gate lines. The first and the second data lines are configured for providing display data, and are disposed adjacent to each other. Each of the pixels receives display data provided by one of the first data line and the second data line. The gate lines include a first to an eighth gate line disposed in order. When two pixels electrically connected to the first and the second data lines respectively, and disposed between the first and the second data lines and between the first and the fourth gate lines are driven by one of the first and the fourth gate lines, two pixels electrically connected to the first and the second data lines respectively, and disposed between the first and the second data lines and between the fifth and the eighth gate lines are driven by one of the sixth and the seventh gate lines.

According to one embodiment of the disclosure, a third exemplary half source driving display panel is provided. The display panel includes a first data line, a second data line, a plurality of pixels and a plurality of gate lines. The first and the second data lines are configured for providing display data, and are disposed adjacent to each other. Each of the pixels receives display data provided by one of the first data line and the second data line. The gate lines include a first to an eighth gate line disposed in order. When two pixels electrically connected to the first and the second data lines respectively, and disposed between the first and the second data lines and between the first and the fourth gate lines are driven by one of the second and the third gate lines, two pixels electrically connected to the first and the second data lines respectively, and disposed between the first and the second data lines and between the fifth and the eighth gate lines are driven by one of the fifth and the eighth gate lines.

According to one embodiment of the disclosure, a fourth exemplary half source driving display panel is provided. The display panel includes a plurality of data lines, a plurality of gate lines and a plurality of pixels. The data lines include a first to a fourth data line disposed in order. The gate lines include a first to a fourth gate line disposed in order. Each of the pixels receives display data from one of the data lines. Two pixels of a first area disposed between the first and the second gate lines and between the first and the second data lines, and two pixels of a second area disposed between the first and the second gate lines and between the third and the fourth data lines both are driven by one of the first and the second gate line. Two pixels of a third area disposed between the first and the second gate line and between the second and the third data line are driven by the other one of the first and the second gate lines. When the two pixels of the first area are driven by the first gate line, two pixels of a fourth area disposed between the third and the fourth gate lines and between the first and the second data lines are driven by the fourth gate line. When the two pixels of the first area are driven by the second gate line, the two pixels of the fourth area are driven by the third gate line. In addition, two pixels disposed between the third and the fourth gate lines and between the third and the fourth data lines are driven by the same gate line driving the two pixels of the fourth area, and two pixels disposed between the third and the fourth gate lines and between the second and third data lines are driven by a gate line different from the gate line driving the two pixels of the fourth area.

In the disclosure, the polarities of adjacent pixels in the same row are opposite to each other. Thus, the non-uniformity of the brightness of the display image sensed by human eyes in the lateral vision is reduced. Therefore, the display panel has an improved visual quality.

### BRIEF DESCRIPTION OF THE DRAWINGS

The present invention will become more readily apparent to those ordinarily skilled in the art after reviewing the following detailed description and accompanying drawings, in which:

FIG. 1 is a schematic pixel array diagram of a conventional half source driving display panel.

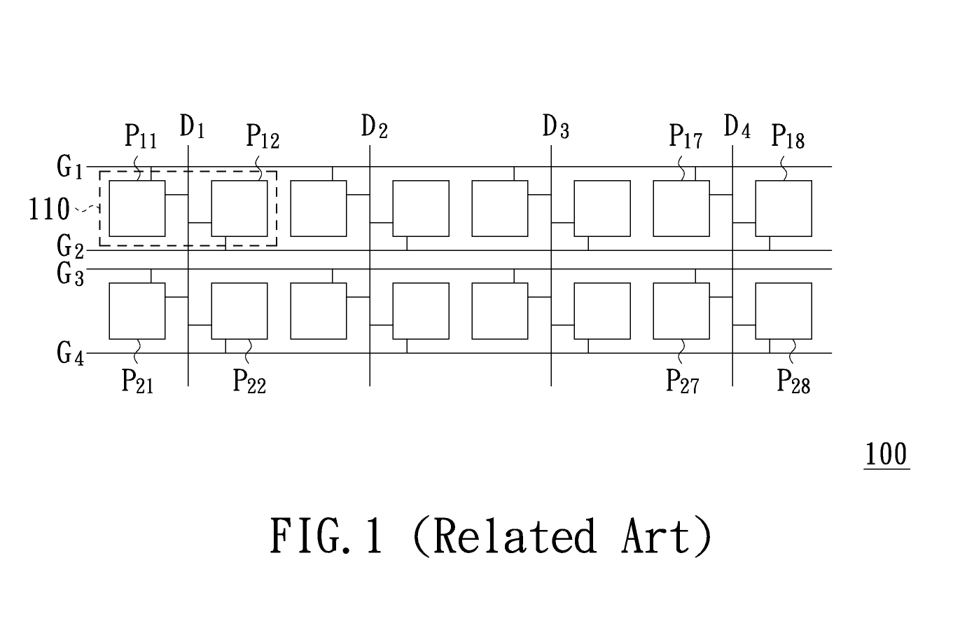

FIG. 2 schematically shows a gray level display image and a pixel polarity distribution diagram of FIG. 1.

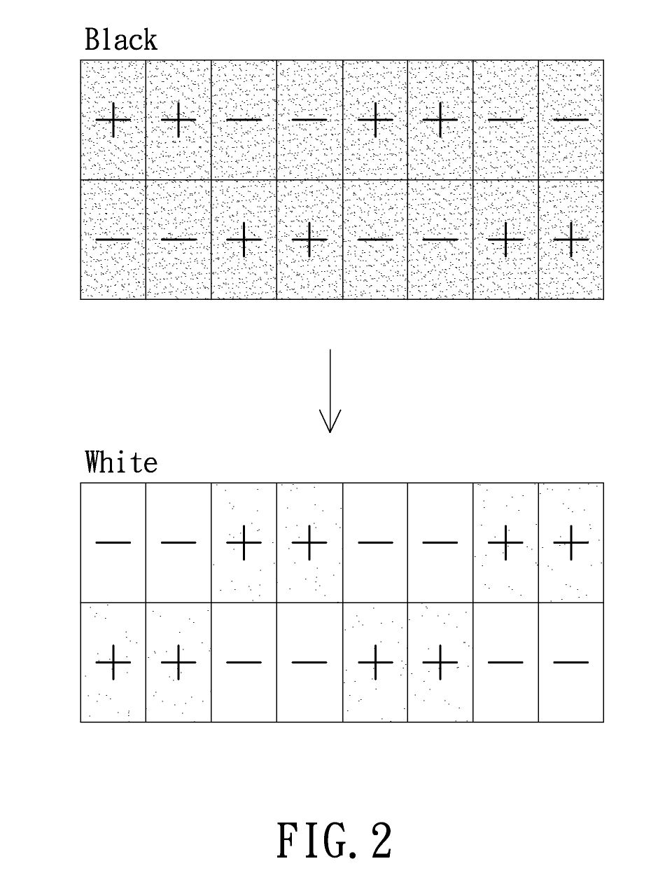

FIG. 3 is a schematic pixel array diagram of a half source driving display panel according to a first exemplary embodiment.

FIG. 4 is a schematic pixel array diagram of a half source driving display panel according to a second exemplary embodiment.

FIG. 5 is a schematic pixel array diagram of a half source driving display panel according to a third exemplary embodiment.

FIG. 6 is a schematic pixel array diagram of a half source driving display panel according to a fourth exemplary embodiment.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

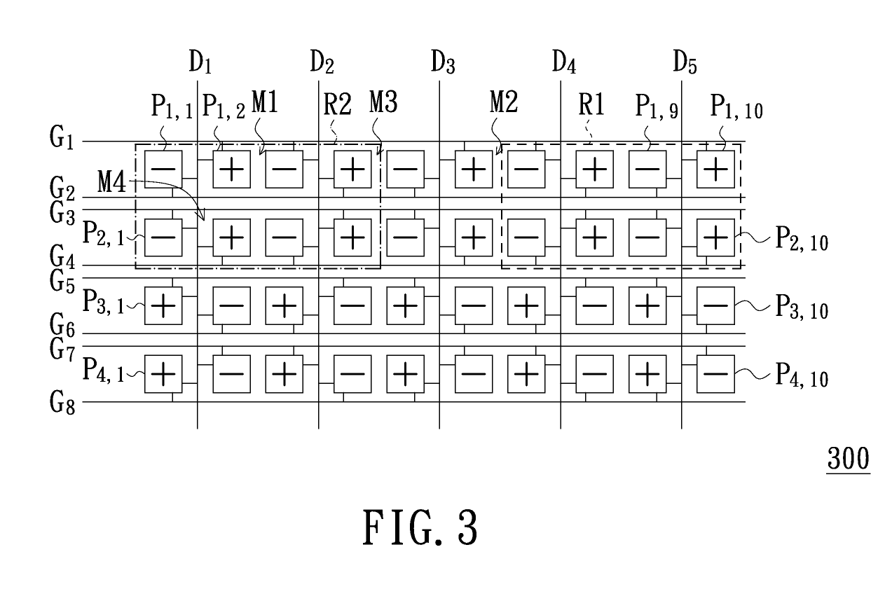

FIG. 3 shows a schematic pixel array diagram of a first exemplary half source driving display panel 300. The display panel 300 includes a plurality of data lines D₁˜D₅, a plurality of gate lines G₁˜G₈ and a plurality of pixels P_{1,1}˜P_{4,10}. The gate lines G₁˜G₈ includes a first gate line G₁ to an eighth gate line G₈ disposed in order. The data lines D₁˜D₅ includes a first data line D₁ to a fifth data line D₅ disposed in order. A pixel P_{x,y} is defined as a pixel dispose in row x, column y, wherein 1≦x≦4, 1≦y≦10. For example, the pixel P_{1,2} represents a pixel positioned on the first row, the second column, and so on. A first display area R1 is defined as a display array electrically connecting both to one of the first gate line G₁ to the fourth gate line G₄ and one of the fourth data line D₄ and the fifth data line D₅. A second display area R2 is defined as a display array electrically connecting both to one of the first gate line G₁ to the fourth gate line G₄ and one of the first data line D₁ and the second data line D₂.

The data lines D₁˜D₅ are configured to providing display data. The pixels respectively receive display data from corresponding data lines electrically connected thereto. The gate lines G₁˜G₈ sequentially receive gate driving signals transmitted from a gate driving circuit (not shown) to control the pixels electrically connected to the same gate lines whether receive display data from the data lines electrically connected thereto. In order to clearly describe the concept in detail, a number of embodiments will be disclosed to introduce a pixel array arrangement of the half source driving display panel 300 as follows.

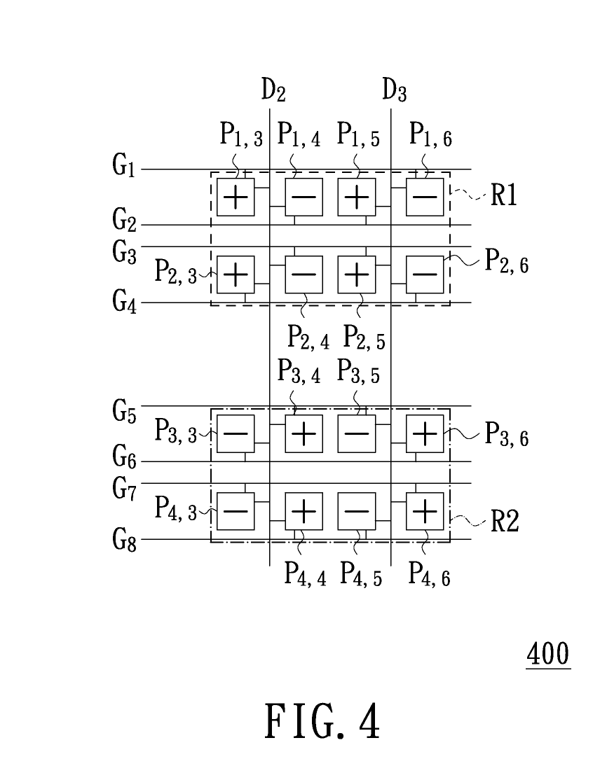

FIG. 4 is a schematic pixel array diagram of a second exemplary half source driving display panel 400. Referring to FIGS. 3 and 4, the half source driving display panel 400 includes a first data line D₂, a second data line D₃, a plurality of pixels P_{1,3}˜P_{4,6} and a plurality of gate lines G₁˜G₈.

The first and second data lines D₂ and D₃ are used to providing display data, and are adjacent to each other. The pixels P_{1,3}˜P_{4,6} receive display data provided from the first data line D₂ or the second data line D₃. The gate lines G₁˜G₄ includes a first gate line G₁, a second gate line G₂, a third gate line G₃ and a fourth gate line G₄ arranged in order. The first data line D₂ and the second data line D₃ are electrically coupled to each other. Two pixels P_{1,4} and P_{1,5}, which are electrically connected to and disposed between the first and second data lines D₂ and D₃, and positioned between the first and second gate lines G₁ and G₂, are driven by the second gate line G₂. Two pixels P_{1,3} and P_{1,6}, which are electrically connected to and disposed outside the first and second data lines D₂ and D₃, and positioned between the first and second gate lines G₁ and G₂, are driven by the first gate line G₁. Two pixels P_{2,4} and P_{2,5}, which are electrically connected to and disposed between the first and second data lines D₂ and D₃, and positioned between the third and fourth gate lines G₃ and G₄, are driven by the third gate line G₃. Two pixels P_{2,3} and P_{2,6}, which are electrically connected to and disposed outside, or in other words, not between, the first and second data lines D₂ and D₃, and positioned between the third and fourth gate lines G₃ and G₄, are driven by the fourth gate line G₄.

In detail, there are four pixels P_{1,3}˜P_{1,6} arranged between the first and second gate lines G₁ and G₂, wherein two pixels P_{1,3} and P_{1,4} are respectively disposed at opposite sides of the first data line D₂ and both electrically connected to the first gate line G₁, and the other two pixels P_{1,5} and P_{1,6} are respectively disposed at opposite sides of the second data line D₃ and electrically connected to the second data line D₃. The two pixels P_{1,4} and P_{1,5} disposed between the first and second data lines D₂ and D₃ and between the first and second gate lines G₁ and G₂ are electrically connected to and driven by the second gate line G₂. The other two pixels P_{1,3} and P_{1,6} disposed outside the first and second data lines D₂ and D₃ are electrically coupled to and driven by the first gate line G₁. In addition, there are four pixels P_{2,3}˜P_{2,6} arranged between the third and fourth gate lines G₃ and G₄ in the same way, wherein two pixels P_{2,3} and P_{2,4} are respectively disposed at opposite sides of the first data line D₂ and electrically connected to the first data line D₂, and the other two pixels P_{2,5} and P_{2,6} are respectively disposed at opposite sides of the second data line D₃ and electrically connected to the second data line D₃. Two pixels P_{2,4} and P_{2,5} disposed between the first and second data lines D₂ and D₃ and between the third and fourth gate lines G₃ and G₄ are electrically coupled to and driven by the third gate line G₃. The other two pixels P_{2,3} and P_{2,6} disposed outside the first and second data lines D₂ and D₃ are electrically connected to and driven by the fourth gate line G₄.

The gate lines G₁˜G₄ sequentially receive gate driving signals transmitted from a gate driving circuit (not shown) to control the pixels electrically connected to the same gate lines whether receive the display data from the data lines D₂/D₃ electrically connected thereto. During a period for displaying a frame of image, the polarities of the display data transmitted by the first data line D₂ are positive, negative, negative, and positive in order, and the polarities of the display data transmitted by the second data line D₃ are negative, positive, positive, and negative in order. That is to say, the pixel P_{1,3} electrically connected both to the first gate line G₁ and the first data line D₂ receives a positive display data, the pixel P_{1,4} electrically connected both to the second gate line G₂ and the first data line D₂ receives a negative display data, the pixel P_{2,4} electrically connected both to the third gate line G₃ and the first data line D₂ receives a negative display data, the pixel P_{2,3} electrically connected both to the fourth gate line G₄ and the first data line D₂ receives a positive display data. And so forth, the pixels P_{1,6}, P_{1,5}, P_{2,5} and P_{2,6} respectively receive the display data having polarities of negative, positive, positive, and negative. In another period for displaying a frame of image, the first data line D₂ transmits display data having polarities of negative, positive, positive and negative in order, and the second data line D₃ transmits display data having polarities of positive, negative, negative, and positive in order.

The half source driving display panel 400 further includes a fifth gate line G₅, a sixth gate line G₆, a seventh gate line G₇, and an eighth gate line G₈ disposed following the fourth gate line G₄ in order. Two pixels P_{3,4} and P_{3,5}, which are electrically connected to first data line D₂ or second data line D₃ and both disposed between the first and the second data lines D₂ and D₃, and are disposed between the fifth and the sixth gate lines G₅ and G₆, are driven by the fifth gate line G₅. Two pixels P_{3,3} and P_{3,6}, which are electrically connected to the first data line D₂ or the second data line D₃ and disposed outside the first and the second data lines D₂ and D₃, and are both disposed between the fifth and the sixth gate lines G5 and G6, are driven by the sixth gate line G₆. Two pixels P_{4,4} and P_{4,5}, which are electrically connected to the first data line D₂ or the second data line D₃ and both disposed between the first and the second data lines D₂ and D₃, and are disposed between the seventh and the eighth gate lines G₇ and G₈, are driven by the eighth gate line G₈. Two pixels P_{4,3} and P_{4,6}, which are electrically connected to the first data line D₂ or the second data line D₃ and both disposed outside the first and the second data lines D₂ and D₃, and are disposed between the seventh and the eighth gate lines G₇ and G₈, are driven by the seventh gate line G₇.

Similarly, during a period for displaying a frame of image, the polarities of the display data transmitted from the first data line D₂ to the pixels electrically connected to the gate lines G₁˜G₈ can be, for example, positive, negative, negative, positive, positive, negative, negative, and positive in order, and the polarities of the display data transmitted from the second data line D₃ can be, for example, negative, positive, positive, negative, negative, positive, positive and negative in order. Thus, the polarities of adjacent pixels in the same row are opposite to each other. When the pixels receive the display data of a following frame of image having opposite polarity, the problem, that the uniformity of the brightness of the display image is affected by a difference between a response time of the polarity of the liquid crystal changing from positive to negative and a response time of the polarity of the liquid crystal changing from negative to positive, will be unobvious due to the human eyes sensitivity to the differences of lateral vision. Therefore, the display panel has an improved visual quality.

Referring both to FIGS. 3 and 4, the half source driving display panel 400 has a pixel array arrangement equal to an arrangement of disposing the first display area R1 and the second display area R2 of the half source driving display panel 300 in an upper and lower order.

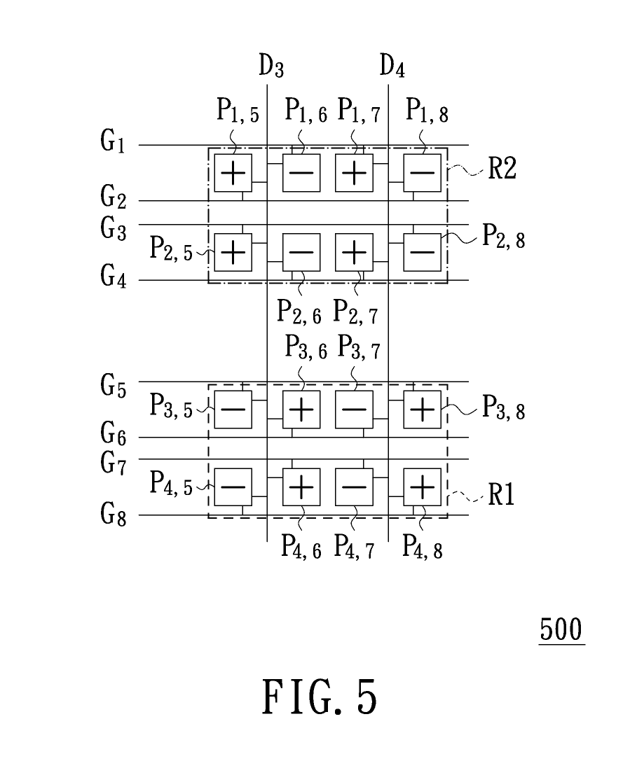

FIG. 5 illustrates a schematic pixel array diagram of a half source driving display panel 500 according to a third exemplary embodiment. The display panel 500 has a similar structure to that of the display panel 400, and will be described in detail as follows.

In the display panel 500, two pixels P_{1,6} and P_{1,7} disposed between the first and the second data lines D₃ and D₄ and between the first and the fourth gate lines G₁ and G₄ are electrically connected to the first gate line G₁, and the other two pixels P_{2,6} and P_{2,7} arranged between the same data lines and the same gate lines are electrically connected to the fourth gate line G₄. Two pixels P_{3,6} and P_{3,7} disposed between the first and the second data lines D₃ and D₄ and between the fifth and the eighth gate lines G₅ and G₈ are driven by the sixth gate line G₆, and the other two pixels P_{4,6} and P_{4,7} arranged between the same data lines and the same gate lines are driven by the seventh gate line G₇. Two pixels P_{1,5} and P_{1,8} disposed outside the first and the second data lines D₃ and D₄ and between the first and the fourth gate lines G₁ and G₄ are electrically connected to the second gate line G₂, and the other two pixels P_{2,5} and P_{2,8} arranged outside the same data lines and between the same gate lines are electrically connected to the third gate line G₃. Two pixels P_{3,5} and P_{3,8} disposed between the first and the second data lines D₃ and D₄ and outside the fifth and the eighth gate lines G₅ and G₈ are driven by the fifth gate line G₅, and the other two pixels P_{4,5} and P_{4,8} arranged between the same data lines and outside the same gate lines are driven by the eighth gate line G₈.

That is to say, the half source driving display panel 500 has a pixel array arrangement equal to an arrangement of disposing the second display area R2 and the first display area R1 of the half source driving display panel 300 in an upper and lower order. The half source driving display panel 500 works following a same principle as the half source driving display panel 400, and will not be repeated here.

It is worth to mention that, the display panel 300 can be regarded as an equal arrangement of repeatedly disposing the display panel 400 or the display panel 500 as a sub-pixel array. The half source driving display panel 300 works following the same principle as the half source driving display panel 400. During a period for displaying a frame of image, the polarities of the display data transmitted from the first data line D₁ and/or the third data line D₃, the fifth data line D₅ to the pixels electronically connected to the gate lines G₁˜G₈ can be, for example, positive, negative, negative, positive, positive, negative, negative, and positive in order, and the polarities of the display data transmitted from the second data line D₂ and/or the fourth data line D₄ can be, for example, negative, positive, positive, negative, negative, positive, positive and negative in order. In another period for displaying a frame of image, the polarities of the display data transmitted from the first data line D₁ and/or the third data line D₃, the fifth data line D₅ can be negative, positive, positive, negative, negative, positive, positive and negative in order, and the polarities of the display data transmitted from the second data line D₂ and/or the fourth data line D₄ can be positive, negative, negative, positive, positive, negative, negative, and positive in order.

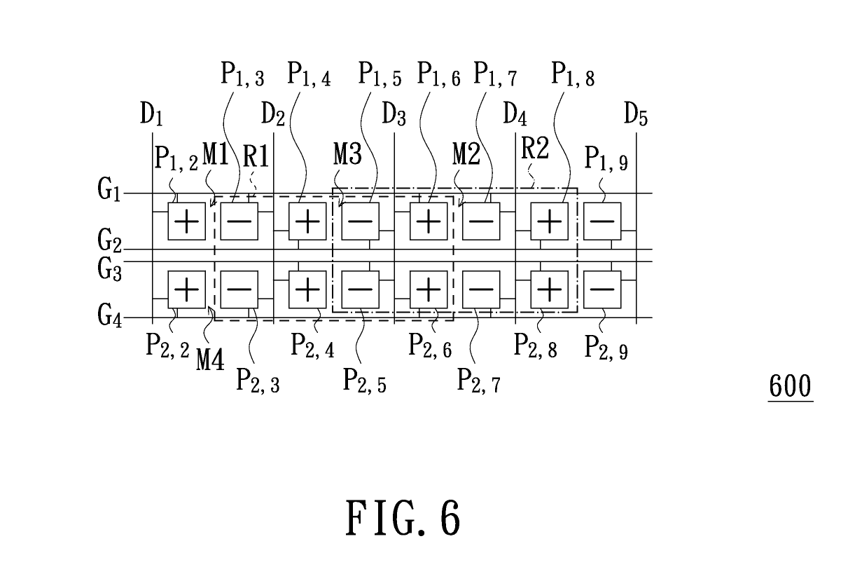

FIG. 6 shows a schematic pixel array diagram of a half source driving display panel 600 according to a fourth embodiment. The display panel 600 includes a plurality of data lines D₁˜D₅, a plurality of gate lines G₁˜G₄ and a plurality of pixels P_{1,2}˜P_{2,9}. The data lines D₁˜D₄ includes a first data line D₁ to a fourth data line D₄ disposed in order. The gate lines G₁˜G₄ includes a first gate line G₁ to a fourth gate line G₄ disposed in order. A first area M1 is defined between the first and the second gate lines G₁ and G₂ and between the first and the second data lines D₁ and D₂. A second area M2 is defined between the first and the second gate lines G₁ and G₂ and between the third and the fourth data lines D₃ and D₄. Two pixels P_{1,2} and P_{1,3} positioned in the first area M1 and two pixels P_{1,6} and P_{1,7} positioned in the second area M2 both are driven by one of the first and the second gate lines G₁ and G₂. A third area M3 is defined between the first and the second gate lines G₁ and G₂ and between the second and the third data lines D₂ and D₃. Two pixels P_{1,4} and P_{1,5} positioned in the third area M3 are driven by the other one of the first and the second gate lines G₁ and G₂.

When the two pixels P_{1,2} and P_{1,3} disposed in the first area M1 are electrically connected to the first gate line G₁, two pixels P_{2,2} and P_{2,3} arranged in a fourth area M4, which is defined between the third and the fourth gate line G₃ and G₄ and between the first and the second data lines D₁ and D₂, are electrically coupled to the fourth gate line G₄. Alternatively, when the two pixels P_{1,2} and P_{1,3} disposed in the first area M1 are electrically connected to the second gate line G2, the two pixels P_{2,2} and P_{2,3} arranged in the fourth area M4 are electrically coupled to the third gate line G₃.

Two pixels P_{2,6} and P_{2,7}, which are disposed between the third and the fourth gate lines G₃ and G₄ and between the third and the fourth data lines D₃ and D₄, and the two pixels P_{2,2} and P_{2,3} disposed in the fourth area M4 are electrically connected to the same gate line. Two pixels P_{2,4} and P_{2,5}, which are disposed between the third and the fourth gate lines G₃ and G₄ and between the second and the third data lines D₂ and D₃, and the two pixels P_{2,2} and P_{2,3} disposed in the fourth area M4 are electrically connected to different gate lines. In another words, in the present embodiment, the two pixels P_{2,2} and P_{2,3} in the fourth area M4 are electrically connected to the fourth gate line G4, and the two pixels P_{2,4} and P_{2,5}, disposed between the third and the fourth gate lines G₃ and G₄ and between the second and the third data lines D₂ and D₃, are electrically connected to the third gate line G₃.

And so forth, the two pixels P_{1,8} and P_{1,9} positioned between the first and the second gate lines G₁ and G₂ and between the fourth and the fifth data lines D₄ and D₅ are electrically connected to the second gate line G₂, and the two pixels P_{2,8} and P_{2,9} positioned between the third and the fourth gate lines G₃ and G₄ and between the fourth and the fifth data lines D₄ and D₅ are electrically connected to the third gate line G₃. In other words, the pixels disposed in an area defined between two gate lines are electrically connected to one of the gate lines, and the pixels disposed in an adjacent area defined between the same gate lines are electrically connected to the other one of the gate lines.

In another aspect, the pixel array formed by the pixels electrically connected to the second data line D₂ or the third data line D₃ is similar to the pixel array arrangement of the first display area R1 of the display panel 300. In addition, the pixel array formed by the pixels electrically connected to the third data line D₃ or the fourth data line D₄ is similar to the pixel array arrangement of the second display area R2 of the display panel 300.

In the disclosure, the polarities of adjacent pixels in the same row are opposite to each other. When the pixels receive the display data of a following frame of image having opposite polarities, the changing areas each consisting of two adjacent pixels in the same row as disclosed in the conventional display panel is reduced to consisting of only one pixel in the same row as disclosed in the disclosure. Thus, the non-uniformity of the brightness of the display image sensed by human eyes in the lateral vision is reduced. Therefore, the display panel has an improved visual quality.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A half source driving display panel, comprising:
a first data line configured for providing display data;
a second data line adjacent to the first data line, and configured for providing display data;
a plurality of pixels, each being configured for receiving display data provided by one of the first data line and the second data line; and
a plurality of gate lines comprising a first gate line, a second gate line, a third gate line and a fourth gate line in order;
wherein, two pixels electrically connected to the first and the second data lines respectively, and disposed between the first and the second data lines and between the first and the second gate lines are driven by the second gate line; two pixels electrically connected to the first and the second data lines respectively, and disposed outside the first and the second data lines and between the first and second gate lines are driven by the first gate line; two pixels electrically connected to the first and the second data lines respectively, and disposed between the first and second data lines and between the third and the fourth gate lines are driven by the third gate line; and two pixels electrically connected to the first and second data lines, and disposed respectively outside the first and the second data lines and between the third and the fourth gate lines are driven by the fourth gate line.

2. The half source driving display panel according to claim 1, wherein the gate lines further comprises a fifth gate line, a sixth gate line, a seventh gate line, and a eighth gate line disposed following the fourth gate line in order;
two pixels electrically connected to the first and the second data lines respectively, and disposed between the first and the second data lines and between the fifth and the sixth gate lines are driven by the fifth gate line;
two pixels electrically connected to the first and the second data lines respectively, and disposed outside the first and the second data lines and between the fifth and the sixth gate lines are driven by the sixth gate line;
two pixels electrically connected to the first and the second data lines respectively, and disposed between the first and the second data lines and between the seventh and the eighth gate lines are driven by the eighth gate line; and
two pixels electrically connected to the first and the second data lines respectively, and disposed outside the first and the second data lines and between the seventh and the eighth gate lines are driven by the seventh gate line.

3. A half source driving display panel, comprising:
a first data line configured for providing display data;
a second data line adjacent to the first data line, and configured for providing display data;
a plurality of pixels, each being configured for receiving display data provided by one of the first and the second data lines; and
a plurality of gate lines comprising a first gate line, a second gate line, a third gate line, a fourth gate line, a fifth gate line, a sixth gate line, a seventh gate line, and a eighth gate line in order;
wherein, when two pixels electrically connected to the first and the second data lines respectively, and disposed between the first and the second data lines and between the first and the fourth gate lines are driven by one of the first and the fourth gate lines, two pixels electrically connected to the first and the second data lines respectively, and disposed between the first and the second data lines and between the fifth and the eighth gate lines are driven by one of the sixth and the seventh gate lines.

4. A half source driving display panel, comprising:
a first data line configured for providing display data;
a second data line adjacent to the first data line, and configured for providing display data;
a plurality of pixels, each being configured for receiving display data provided by one of the first and the second data lines; and
a plurality of gate lines comprising a first gate line, a second gate line, a third gate line, a fourth gate line, a fifth gate line, a sixth gate line, a seventh gate line, and a eighth gate line in order;
wherein, when two pixels electrically connected to the first and the second data lines respectively, and disposed between the first and the second data lines and between the first and the fourth gate lines are driven by one of the second and the third gate lines, two pixels electrically connected to the first and the second data lines respectively, and disposed between the first and the second data lines and between the fifth and the eighth gate lines are driven by one of the fifth and the eighth gate lines.

5. The half source driving display panel according to claim 4, wherein when two pixels electrically connected to the first and the second data lines respectively, and disposed between the first and the second data lines and between the first and the fourth gate lines are driven by one of the first and the fourth gate lines, two pixels electrically connected to the first and the second data lines respectively, and disposed between the first and the second data lines and between the fifth and the eighth gate lines are driven by one of the sixth and the seventh gate lines.

6. A half source driving display panel, comprising:
a plurality of data lines comprising a first to a fourth data line disposed in order;
a plurality of gate lines comprising a first to a fourth gate line disposed in order; and
a plurality of pixels, each being configured for receiving display data from one of the data lines;
wherein two pixels of a first area disposed between the first and the second gate lines and between the first and the second data lines, and two pixels of a second area disposed between the first and the second gate lines and between the third and the fourth data lines both are driven by one of the first and the second gate line; two pixels of a third area disposed between the first and the second gate line and between the second and the third data line are driven by the other one of the first and the second gate lines;
when the two pixels of the first area are driven by the first gate line, two pixels of a fourth area disposed between the third and the fourth gate lines and between the first and the second data lines are driven by the fourth gate line; when the two pixels of the first area are driven by the second gate line, the two pixels of the fourth area are driven by the third gate line; and
two pixels disposed between the third and the fourth gate lines and between the third and the fourth data lines being driven by the same gate line driving the two pixels of the fourth area, two pixels disposed between the third and the fourth gate lines and between the second and third data lines being driven by a gate line different from a gate line driving the two pixels of the fourth area.
